(19) United States
(12) Patent Application Publication
(10) Pub. No.: US 2009/0128443 A1
(43) Pub. Date: May 21, 2009

(54) Fixing device of a radiator sheet

(76) Inventor: Chin-Hsing Horng, Taoyuan (TW)

Correspondence Address: Meng-Tsuey, Pan, P.O. Box 1-252, Sanchung, TW

(21) Appl. No.: 11/985,148

(22) Filed: Nov. 15, 2007

(51) Int. Cl. H01Q 1/12

(52) U.S. Cl. 343/878

(57) ABSTRACT

A fixing device of a radiator sheet comprises more than one pair of apertures and more than one pair of hooks; the apertures are shaped as rectangular or elongated circular holes and disposed on the upper and lower folding plates of a sheet body. The hooks are shaped as either a horizontally-tilted “U” with an upper hook or a horizontally-tilted “U” with a lower hook, and are disposed on a junction between the upper and lower folding plates and the sheet body in correspondence to each of the apertures. Moreover, at least one or more square-bracket concavities, inclined concavities, or parenthesis-inclined concavities are respectively disposed on the upper and lower folding plates.

### FIELD OF THE INVENTION

The invention relates to a fixing device of a radiator sheet, and more particularly to a fixing device of a radiator sheet that may be firmly and stably connected to each other in parallel.

### DESCRIPTION OF THE PRIOR ART

In the conventional fixing devices of a radiator sheet (also called the connecting devices or the clasping devices) as disclosed in the R.O.C. Patent No. 468931, No. 524343, No. 484704, and No. 558009, as well as in the U.S. Pat. No. 6,499,160B1, No. 6,382,307B1, and No. 6,619,381B1, one or more than one pair of hooks are respectively disposed on the upper and lower folding plates on each sheet body, and a hooking portion, a fastener or a clasp is extended from the edges of the upper and lower folding plates that correspond to the hooks. The hooking portion, fastener or clasp on the upper and lower folding plates on a sheet body of a previous radiator sheet may be coupled to a corresponding aperture on a sheet body of a next radiator sheet, so as to integrally connect multiple radiator sheets in parallel. However, because such hooks (or hooking portions, fasteners, and clasps) are simply inserted into the apertures to achieve connection, and are not firmly secured to the apertures; when multiple radiator sheets are integrally connected in parallel to make up a row of connected radiator sheets, the radiator sheets are prone to becoming loosened and separated from each other. Moreover, because the upper and the lower folding plates in the conventional radiator sheets do not have any auxiliary supporting structures for holding the connection stably, the radiator sheets are easily loosened and separated from each other when multiple radiator sheets are integrally connected in parallel as described above. As a result, a radiator is rendered difficult to transport or assembled, and is easily damaged and prone to malfunctioning.

### SUMMARY OF THE INVENTION

The conventional fixing devices of a radiator sheet have problems such as infirm and unstable connection that easily lead to loosening and separation of radiator sheets, thus a fixing device of a radiator sheet is disclosed in the invention in an attempt to solve the aforesaid problems.

A primary objective of the invention is to propose a fixing device of a radiator sheet; which allows two sheet bodies of two separate radiator sheets to be firmly connected together and to hold and support each other mutually; the mutual connection is firm, stable, and resistant to loosening or separation.

Folding plates with identical width and facing an identical direction are respectively formed on the upper and lower edges of a sheet body of the radiator sheet, and more than one or one pair of rectangular or elongated circular holes are respectively disposed on the folding plates, so as to serve as apertures for the fixing device of the radiator sheet in the invention. To achieve the objective of the invention, hooks on the fixing device of the radiator sheet are shaped as either a horizontally-tilted “U” with an upper hook or a horizontally-tilted “U” with a lower hook, and are disposed on a junction between the upper and lower folding plates and the sheet body in correspondence to each of the apertures. Furthermore, at least one or more square-bracket concavities or parenthesis-inclined concavities or inclined concavities are respectively disposed on the upper and lower folding plates. When multiple radiator sheets are integrally connected in parallel, two sheet bodies of two separate radiator sheets may be firmly connected together and may hold and support each other mutually; thus, the connection is firm, stable, and resistant to loosening or separation.

### BRIEF DESCRIPTION OF DRAWINGS

The structure and the technical means adopted by the present invention to achieve the above and other objectives can be best understood by referring to the following detailed description of the preferred embodiments and the accompanying diagrams, wherein:

FIG. 1 is a bottom view that shows a radiator sheet according to the invention;

FIG. 2 is a top view that shows the radiator sheet according to the invention;

FIG. 3 is a blown-up bottom view that shows a part of the radiator sheet according to the invention;

FIG. 4 is a schematic view that indicates three different states of the radiator sheet of the invention; wherein one shows a single unit of radiator sheet, another shows two radiator sheets are connected to each other, and the other shows the multiple radiator sheets are connected in parallel.

### DETAILED DESCRIPTION OF PREFERRED EMBODIMENTS

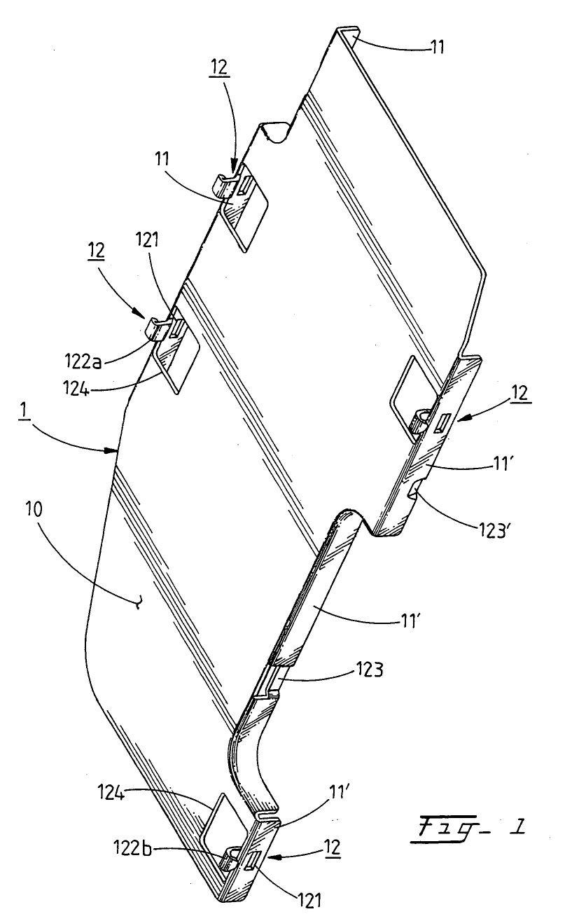

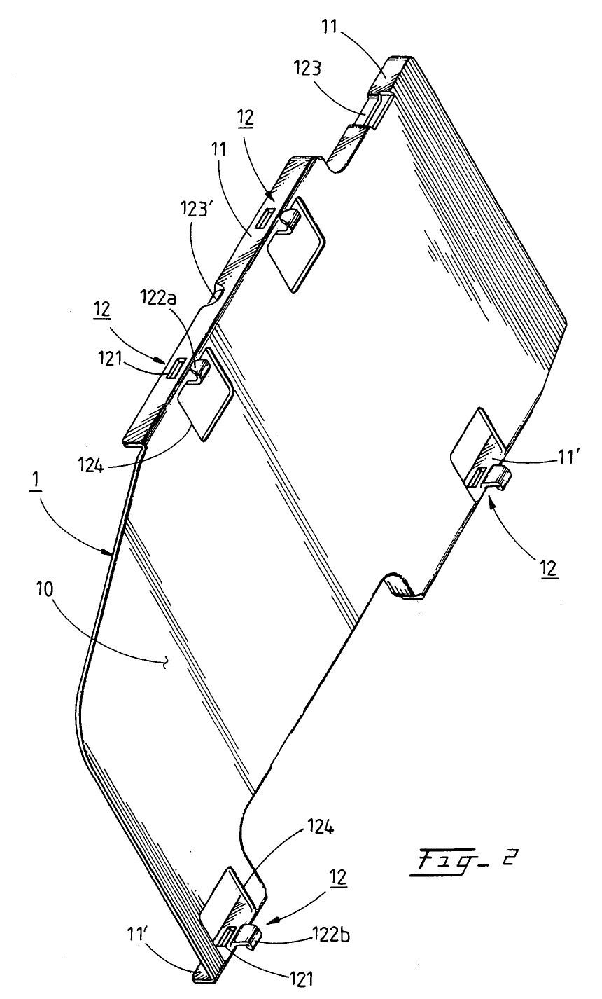

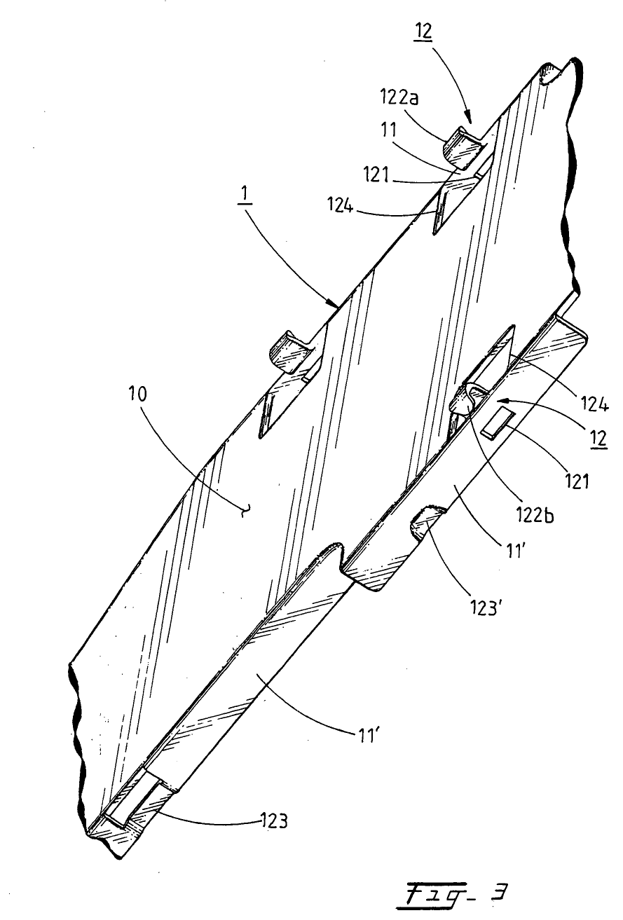

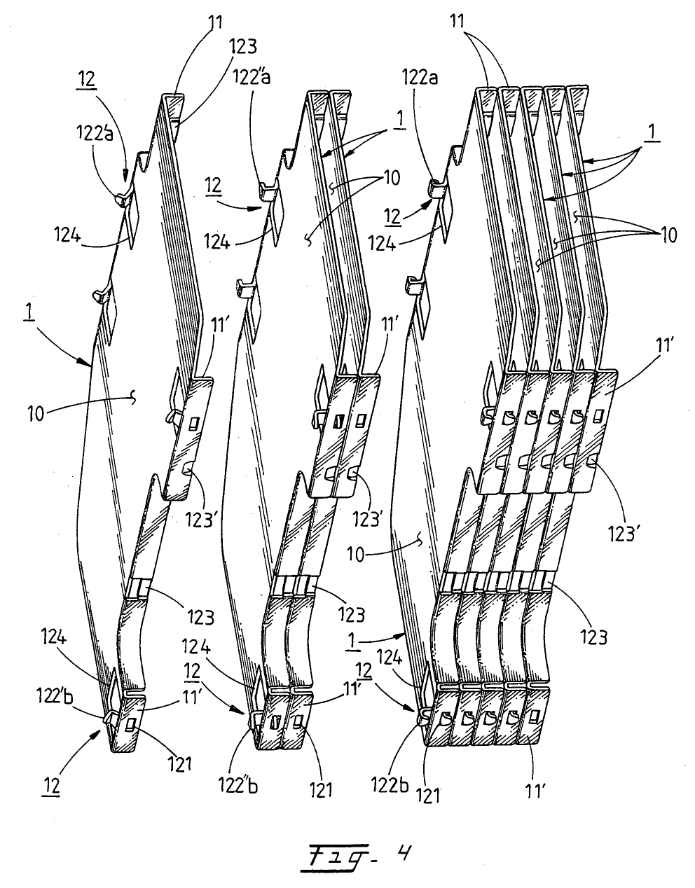

As shown in FIGS. 1 and 2, a sheet body 10 of each radiator sheet 1 of the invention is structurally identical to that of conventional radiator sheets; wherein an upper folding plate 11 and a lower folding plate 11′ with identical width and facing an identical direction are respectively formed on upper and lower edges of the sheet body 10, and more than one pair of fixing devices 12 are respectively disposed on each of the upper and lower folding plates 11, 11′; each of the fixing devices 12 is comprised of an aperture 121 and an upper hook 122a or a lower hook 122b; each of the apertures 121 is shaped as rectangular or elongated circular hole and respectively disposed on the upper and lower folding plates 11 and 11′. It should be noted that the upper hook 122a and the lower hook 122b are not directly extended from edges of the upper and lower folding plates 11, 11′, but respectively disposed on a junction between the upper and lower folding plates 11, 11′ and the sheet body 10 in correspondence to each of the apertures 121, and are shaped as either a horizontally-tilted “U” with an upper hook or a horizontally-tilted “U” with a lower hook (as shown in FIG. 3). Therefore, the horizontally-tilted “U” with an upper hook 122a or the horizontally-tilted “U” with a lower hook 122b on the upper and lower folding plates 11, 11′ of a sheet body 10 of a radiator sheet 1 may be coupled to the corresponding aperture 121 on the upper and lower folding plates 11, 11′ of a sheet body 10 of another radiator sheet 1 (as shown in FIG. 4), consequently allowing the horizontally-tilted “U” with an upper hook 122a and the horizontally-tilted “U” with a lower hook 122b to be firmly secured to each of the apertures 121, so that sheet bodies 10 of two radiator sheets 1 may be stably connected to each other without becoming loosened and separated.

In addition, in order to further enhance the aforesaid connection between the sheet bodies 10 of two radiator sheets 1, at least one or more square-bracket concavities 123, or inclined concavities, or parenthesis-inclined concavities 123′ are respectively disposed on the upper and lower folding plates 11, 11′ of each sheet body 10 of the radiator sheet 1. When sheet bodies 10 of two radiator sheets 1 are connected to each other via fixing devices 12 as described above, the square-bracket concavities 123 or parenthesis-inclined concavities 123′ on the upper and lower folding plates 11, 11′ of a sheet body 10 of a next radiator sheet 1 may press against and support a sheet body 10 of a previous radiator sheet 1, so as to increase stability of the aforesaid connection, keep two neighboring radiator sheets away from each other at a constant distance, and secure the radiator sheets from loosening or separation.

When multiple radiator sheets 1 are to be connected in parallel to give rise to a row of radiator sheets, as indicated in FIG. 4, simply couple the upper and lower hooks 122a, 122b of each fixing device 12 on the upper and lower folding plates 11, 11′ from a sheet body 10 of a previous radiator sheet 1 to corresponding apertures 121 on the upper and lower folding plates 11, 11′ from a sheet body 10 of a next radiator sheet 1, thereby readily connecting a sheet body 10 of a previous radiator sheet 1 to a sheet body 10 of a next radiator sheet 1 (as indicated in the central drawing of FIG. 4). Subsequently, the sheet body 10 of the next radiator sheet 1 is successively connected to a sheet body 10 of a further radiator sheet 1, and thus a row of radiator sheets may be formed by connecting multiple sheet bodies 10 from many radiator sheets 1 together (as indicated in the drawing on the right side of FIG. 4).

In the disclosed fixing device 12, both the upper and lower hooks 122a, 122b appear as horizontally-tilted “U” when being connected to the apertures 121, thus making automatically connecting two radiator sheets in parallel by using a consecutive molding machine more difficult. As a result, when every single sheet body 10 of the invention is firstly molded in a consecutive molding machine (not shown), each of the upper and lower hooks 122a, 122b of each fixing device 12 is respectively formed as a downward-tilting L-shaped hook 122′a and an upward-tilting reversed L-shaped hook 122′b (as indicated in the drawing on the left side of FIG. 4). Subsequently, when the L-shaped hook 122′a is bent upward to form a horizontal L-shaped hook 122″a and the reversed L-shaped hook 122′b is bent downward to form a horizontal reversed L-shaped hook 122″b, the consecutive molding machine is used to insert the horizontal L-shaped hook 122″a and the horizontal reversed L-shaped hook 122″b into corresponding apertures 121 on the upper and lower folding plates 11, 11′ on the sheet body 10 of the next radiator sheet 1 (as indicated in the central drawing of FIG. 4). Once the insertion is completed, the consecutive molding machine automatically bends the horizontal L-shaped hook 122″a and the horizontal reversed L-shaped hook 122″b into a horizontally-tilted “U” with an upper hook 122a and a horizontally-tilted “U” with a lower hook 122b respectively, so as to firmly hold onto the apertures 121 (as indicated in the drawing on the right side of FIG. 4), and allow sheet bodies 10 of two radiator sheets 1 to be connected together securely. When the upper and lower hooks 122a, 122b of the fixing device 12 are being automatically connected to the apertures 121 by the consecutive molding machine, the connecting process is not completed until the upper and lower hooks 122a, 122b have undergone the aforesaid bending processes, thus a window hole 124 is disposed on the sheet body 10 of the radiator sheet 1 immediately underneath the upper hook 122a, and immediately above the lower hook 122b respectively, so as to facilitate the automatic bending processes carried out by the consecutive molding machine.

The preferred embodiments mentioned above are intended for illustrative purpose only and are not meant to restrict the present invention. Any modifications or changes to the embodiments are within scope and spirit of the present invention. The scope of the invention is set forth by the claims below.

What is claimed is:

1. A fixing device of a radiator sheet comprising more than one pair of hooks and more than one pair of apertures respectively disposed on an upper folding plate and a lower folding plate of a sheet body thereof, which is characterized in that:
the hooks are shaped as either a horizontally-tilted “U” with an upper hook or a horizontally-tilted “U” with a lower hook, and are disposed on a junction between the upper and lower folding plates and the sheet body in correspondence to each of the apertures; and
at least one or more square-bracket concavities, inclined concavities, or parenthesis-inclined concavities respectively disposed on the upper and lower folding plates.

2. The fixing device of a radiator sheet of claim 1, further comprising a window hole disposed on the sheet body immediately underneath the horizontally-tilted “U” with an upper hook, and immediately above the horizontally-tilted “U” with a lower hook.
